(19) United States
(12) Patent Application Publication
(10) Pub. No.: US 2022/0178091 A1
(43) Pub. Date: Jun. 9, 2022

(54) MACHINE AND DRIVETRAIN ASSOCIATED WITH MACHINE

(71) Applicant: Caterpillar Paving Products Inc., Brooklyn Park, MN (US)

(72) Inventor: Brian Joe Schlenker, Shoreview, MN (US)

(73) Assignee: Caterpillar Paving Products Inc., Brooklyn Park, MN (US)

(21) Appl. No.: 17/111,642

(22) Filed: Dec. 4, 2020

(51) Int. Cl. E01C 23/088; B60K 17/28; B60K 25/06

(52) U.S. Cl. CPC E01C 23/088; B60K 2025/065; B60K 25/06; B60K 17/28

(57) ABSTRACT

A milling machine includes an engine that generates output power, a rotor that receives the output power from the engine, and a drivetrain coupled to the engine and the rotor for transmitting the output power to the rotor based on a desired output of the rotor. The drivetrain includes a transmission system defining an input end coupled to the engine for receiving the output power therefrom and an output end, wherein the transmission system allows variation in an output of the rotor without altering a load on the engine. The drivetrain includes a power transmitting arrangement coupled to the output end of the transmission system. The drivetrain includes a gearbox coupled to the power transmitting arrangement and the rotor for transmitting the output power to the rotor, wherein the power transmitting arrangement is disposed between the transmission system and the gearbox.

### TECHNICAL FIELD

The present disclosure relates to a machine, and more specifically, to a drivetrain associated with a rotor of the machine.

### BACKGROUND

Machines, such as cold planers, road reclaimers, pavement profilers, roadway planers, rotary mixers, and the like, are designed for performing tasks like scarifying, removing, mixing, or reclaiming material from ground surfaces. These machines typically have a rotor that may be mechanically or hydraulically driven to accomplish the above mentioned tasks. The rotor receives operating power from an engine of the machine. Typically, a rotational speed of the rotor may have to be manually or automatically adjusted based on a nature of the task being performed.

Currently, drivetrains of such machines rely on variation in a speed of the engine or a multi-speed gearbox to achieve different rotor speeds. Further, a design of such drivetrains may not allow variation in rotor speeds when the engine is operating under load. More particularly, the speed of the engine may have to be reduced to change the rotor speed. Accordingly, an operator of the machine may have to stop the machine and reduce the engine speed for changing the rotor speed. This technique may cause an undesirable reduction in machine productivity.

U.S. Pat. No. 10,407,864 describes a work implement requirement determination unit determines a work implement required horsepower on the basis of an operation amount of a work implement operating member and a hydraulic pressure of a hydraulic pump. A transmission requirement determination unit determines a transmission required horsepower on the basis of a vehicle speed and the operation amount of the accelerator operating member. An engine requirement determination unit determines an engine required horsepower on the basis of the work implement required horsepower and the transmission required horsepower. The required throttle determination unit determines a required throttle value based on an engine requirement.

### SUMMARY OF THE DISCLOSURE

In one aspect of the present disclosure, a milling machine is provided. The milling machine includes an engine that generates output power. The milling machine also includes a rotor that receives the output power from the engine. The milling machine further includes a drivetrain coupled to the engine and the rotor for transmitting the output power to the rotor based on a desired output of the rotor. The drivetrain includes a transmission system defining an input end operatively coupled to the engine for receiving the output power therefrom and an output end, wherein the transmission system allows variation in an output of the rotor without altering a load on the engine. The drivetrain also includes a power transmitting arrangement coupled to the output end of the transmission system. The drivetrain further includes a gearbox coupled to the power transmitting arrangement and the rotor for transmitting the output power to the rotor, wherein the power transmitting arrangement is disposed between the transmission system and the gearbox.

In another aspect of the present disclosure, a drivetrain for operating a rotor of a machine at a desired output is provided. The machine includes an engine that generates output power. The drivetrain includes a transmission system defining an input end operatively coupled to the engine for receiving the output power therefrom and an output end, wherein the transmission system allows variation in an output of the rotor without altering a load on the engine. The drivetrain also includes a power transmitting arrangement coupled to the output end of the transmission system. The drivetrain further includes a gearbox coupled to the power transmitting arrangement and the rotor for transmitting the output power to the rotor, wherein the power transmitting arrangement is disposed between the transmission system and the gearbox.

Other features and aspects of this disclosure will be apparent from the following description and the accompanying drawings.

### BRIEF DESCRIPTION OF THE DRAWINGS

FIG. 1 is a side view of an exemplary milling machine;

FIG. 2 is a block diagram illustrating a drivetrain associated with the milling machine of FIG. 1, in accordance with the present disclosure;

FIG. 3 is a line diagram illustrating a transmission system of the drivetrain and a clutch disposed between an engine and the transmission system of the drivetrain;

FIG. 4 is a line diagram illustrating the transmission system and the clutch disposed between the transmission system and a power transmitting arrangement of the drivetrain; and

FIG. 5 is a line diagram illustrating the transmission system and a brake assembly disposed between the transmission system and the power transmitting arrangement.

### DETAILED DESCRIPTION

Wherever possible, the same reference numbers will be used throughout the drawings to refer to the same or the like parts. Wherever possible, corresponding or similar reference numbers will be used throughout the drawings to refer to the same or corresponding parts.

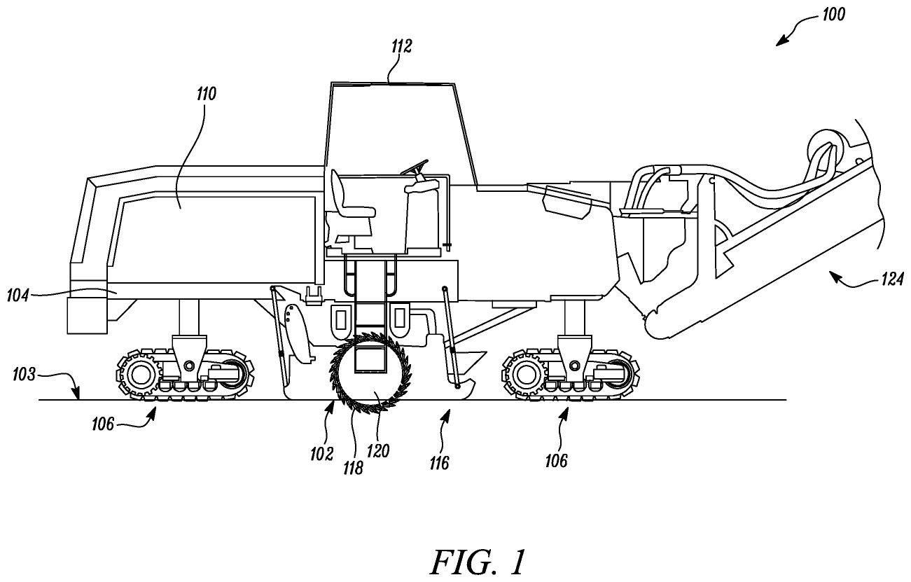

FIG. 1 illustrates an exemplary machine 100. In the illustrated example, the machine 100 is a milling machine. The machine 100 may be hereinafter interchangeably referred to as the milling machine 100. The machine 100 is embodied as a cold planer herein. Although shown as a cold planer, it may be understood that the machine 100 may alternatively include road reclaimers, pavement profilers, roadway planers, rotary mixers, or any other suitable machine having a rotor 102 or a milling device that may be used to scarify, remove, mix, or reclaim material from a ground surface 103. In an example, the ground surface 103 may include bituminous or concrete roadways or other such surfaces. The machine 100 includes a frame 104. The machine 100 also includes a pair of track assemblies 106 supported by the frame 104 that propel the machine 100 on the ground surface 103.

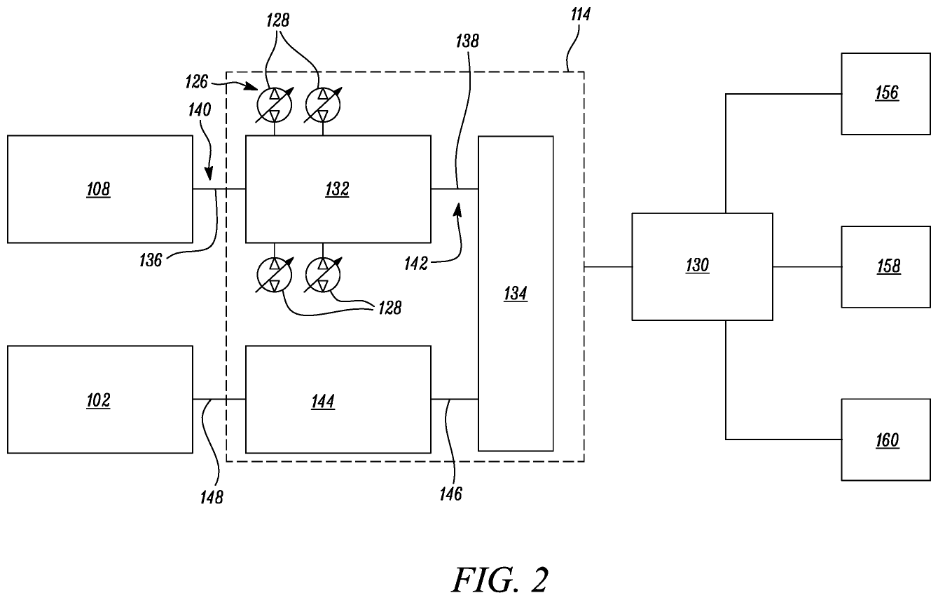

Further, the machine 100 includes an engine 108 (shown in FIG. 2) that generates output power. The engine 108 is received within an engine compartment 110. The engine 108 may be an internal combustion engine. The engine 108 may include a gasoline engine, a diesel engine, a natural gas engine, and the like. The engine 108 may supply the output power to various machine components for operation thereof. The engine 108 is operatively coupled to the track assemblies 106 via a machine transmission system (not shown) for providing operating power to the track assemblies 106.

Further, the machine 100 includes an operator cabin 112. An operator of the machine 100 may sit or stand in the operator cabin 112 for performing one or more machine operations. The operator cabin 112 may include a user interface (not shown). The user interface may include input and output devices for controlling one or more machine components such as the engine 108, the machine transmission system, a drivetrain 114, and the like.

The machine 100 further includes the rotor 102 that receives the output power from the engine 108. The rotor 102 is disposed within a rotor chamber 116. The rotor 102 is disposed in the rotor chamber 116 such that the rotor 102 is exposed to the ground surface 103. The rotor 102 may include a number of cutting assemblies 118 mounted on a drum 120 of the rotor 102. The cutting assemblies 118 contact with the ground surface 103 during a work operation.

Further, a speed of the rotor 102 can be adjusted based on a desired output of the rotor 102. The desired output of the rotor 102 may include a desired rotor speed at which the rotor 102 needs to be operated for accomplishing various work operations. The desired output of the rotor 102 may depend on a number of factors associated with a particular work operation or machine operating parameters. The desired output of the rotor 102 is based on one of a desired depth of cut, a travel speed of the machine 100, a hardness of material being cut, a desired material size, and a density of the material being cut. It should be noted that the factors associated with the work operation and/or the machine operating parameters mentioned above are exemplary in nature and the desired output of the rotor 102 may depend on any other factors, as per application requirements.

Further, the machine 100 may include a number of hydraulic cylinders (not shown) associated with the rotor 102. For example, a height of the rotor 102 with respect to the ground surface 103 may be adjusted in order to adjust the depth of cut, based on extension or retraction of one or more hydraulic cylinders. The machine 100 further includes a conveyor assembly 124 which delivers material removed by the rotor 102 into a receptacle (not shown). More particularly, the conveyor assembly 124 transports materials from the rotor chamber 116 to the receptacle.

Referring to FIG. 2, the machine 100 includes a power take-off system 126 disposed between the engine 108 and the drivetrain 114. The power take-off system 126 receives the output power from the engine 108. The power take-off system 126 includes one or more hydraulic pumps 128. As illustrated, the power take-off system 126 includes four hydraulic pumps 128. The power take-off system 126 directs some portion of the output power from the engine 108 to the hydraulic pumps 128. The hydraulic pumps 128 may in turn provide operating power to a motor (not shown) of the conveyor assembly 124 (see FIG. 1), the hydraulic cylinders for extension/retraction of the rotor 102, the machine transmission system, and/or other machine components, without limiting the scope of the present disclosure.

Further, the power take-off system 126 directs a portion of the output power from the engine 108 to the drivetrain 114 of the machine 100 for operating the rotor 102. In an example, the power take-off system 126 may include a splined shaft to supply the output power of the engine 108 to the drivetrain 114. The machine 100 includes the drivetrain 114 coupled to the engine 108 and the rotor 102 for transmitting the output power to the rotor 102 based on the desired output of the rotor 102. In an example, the drivetrain 114 may transmit or restrict power flow from the engine 108 towards the rotor 102 in an operating condition of the engine 108. In one example, one or more components of the drivetrain 114 may be controlled based on inputs from the operator. Such inputs may be provided via the user interface present in the operator cabin 112 (see FIG. 1). In another example, the components of the drivetrain 114 may be controlled by a controller 130 based on the desired output of the rotor 102. The controller 130 associated with the machine 100 will be explained later in this section.

The drivetrain 114 includes a transmission system 132. The transmission system 132 defines an input end 140 operatively coupled to the engine 108 for receiving the output power therefrom and an output end 142. The transmission system 132 allows variation in an output of the rotor 102 without altering a load on the engine 108. In an example, the input end 140 of the transmission system 132 is coupled with the power take-off system 126. The drivetrain 114 may include a suitable mechanical arrangement (not shown) that operatively couples the power take-off system 126 with the transmission system 132. Such a mechanical arrangement may include an arrangement of pulleys, belts, roller chains, gear drives, and the like. Further, the output end 142 is coupled to a power transmitting arrangement 134 of the drivetrain 114.

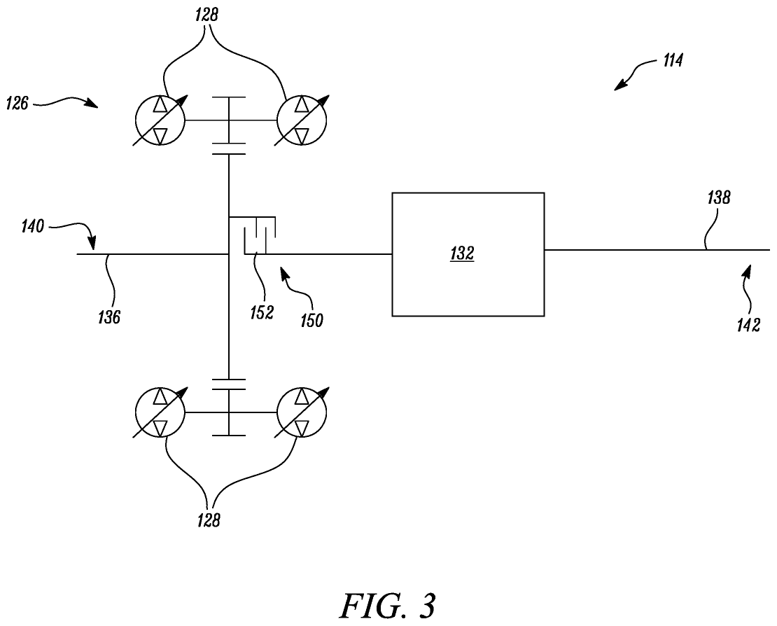

In an example, as shown in FIGS. 2 and 3, the transmission system 132 includes a powershift gearbox. The transmission system 132 provides different drive ratios between the input end 140 and the output end 142 of the transmission system 132. In an example, the transmission system 132 may be designed to provide three drive ratios. However, it should be noted that the transmission system 132 may provide two drive ratios or more than three drive ratios, as per application requirements.

The transmission system 132 includes a first input shaft 136 at the input end 140 and a first output shaft 138 at the output end 142. The first input shaft 136 is coupled with the power take-off system 126 (see FIG. 2). Further, the transmission system 132 includes a planetary transmission. For example, the transmission system 132 may include a single planetary gearset (not shown) having a sun gear, a planet gear, a planet carrier, a ring gear, a brake, and clutches. The transmission system 132 may include two or more clutches. In one example, the transmission system 132 may be similar to the component referred to as “speed unit” in U.S. Pat. No. 4,004,473 assigned to Caterpillar Inc. Further, the transmission system 132 may include multiple planetary gearsets to provide a range of drive ratios.

As shown in FIG. 2, the drivetrain 114 further includes the power transmitting arrangement 134 coupled to the output end 142 of the transmission system 132. The power transmitting arrangement 134 operatively couples the transmission system 132 with a gearbox 144 of the drivetrain 114. The first output shaft 138 of the transmission system 132 is coupled with the power transmitting arrangement 134. The power transmitting arrangement 134 directs an output of the transmission system 132 towards the gearbox 144. The power transmitting arrangement 134 includes one or more of a pulley arrangement, a belt arrangement, a chain arrangement, and a gear drive. It should be noted that the present disclosure is not limited to a type of the power transmitting arrangement 134.

The drivetrain 114 also includes the gearbox 144 coupled to the power transmitting arrangement 134 and the rotor 102 for transmitting the output power to the rotor 102. The power transmitting arrangement 134 is disposed between the transmission system 132 and the gearbox 144. The gearbox 144 receives the output power from the engine 108 through the transmission system 132 and the power transmitting arrangement 134. In an example, the gearbox 144 is a single speed gearbox. In other examples, the gearbox 144 may be embodied as a multi-speed gearbox. The gearbox 144 may provide a number of drive ratios for operation of the rotor 102. The gearbox 144 includes a second input shaft 146 and a second output shaft 148. The second input shaft 146 of the gearbox 144 is operatively coupled to the power transmitting arrangement 134. The second output shaft 148 of the gearbox 144 is operatively coupled to the rotor 102. The gearbox 144 may include a number of gears arranged to provide different drive ratios. In an example, the gearbox 144 may include one or more planetary gearsets. In some examples, the gearbox 144 may include a spur gear arrangement, a helical arrangement, a bevel gear arrangement, and the like, without any limitations.

As shown in FIG. 3, the drivetrain 114 includes a power disengagement device 150 for selectively disengaging the engine 108 (see FIG. 2) from the rotor 102 (see FIG. 2) in the operating condition of the engine 108. The power disengagement device 150 may be engaged to allow power flow from the engine 108 towards the rotor 102 whereas the power disengagement device 150 may be disengaged to prevent power flow from the engine 108 towards the rotor 102.

In one example, the power disengagement device 150 includes a clutch 152 disposed on the input end 140 or the output end 142 of the transmission system 132. In an example, the clutch 152 may be hydraulically operated. The clutch 152 may include one or more of a friction clutch, a single plate clutch, a multi plate clutch, a cone clutch, a centrifugal clutch, or any other type of clutch that can be used for engaging or disengaging two components.

As illustrated in the accompanying figure, the clutch 152 is disposed between the power take-off system 126 and the transmission system 132. The clutch 152 selectively disengages the engine 108 and the drivetrain 114. Specifically, the clutch 152 selectively disengages the engine 108 and the transmission system 132. In an engaged position, the clutch 152 allows transmission of the output power from the engine 108 to the transmission system 132. In a disengaged position, the clutch 152 prevents power flow from the engine 108 towards the transmission system 132.

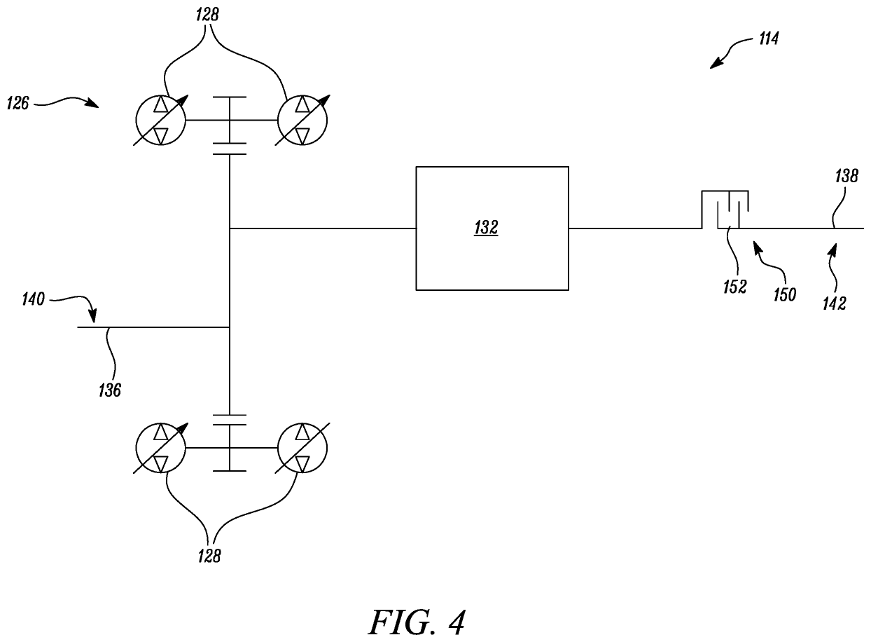

In another example, as illustrated in FIG. 4, the clutch 152 is disposed between the transmission system 132 and the power transmitting arrangement 134 (see FIG. 2). In such an example, the clutch 152 selectively disengages the transmission system 132 and the power transmitting arrangement 134. In an engaged position, the clutch 152 allows transmission of the output power from the transmission system 132 towards the power transmitting arrangement 134. In a disengaged position, the clutch 152 prevents power flow from the transmission system 132 towards the power transmitting arrangement 134.

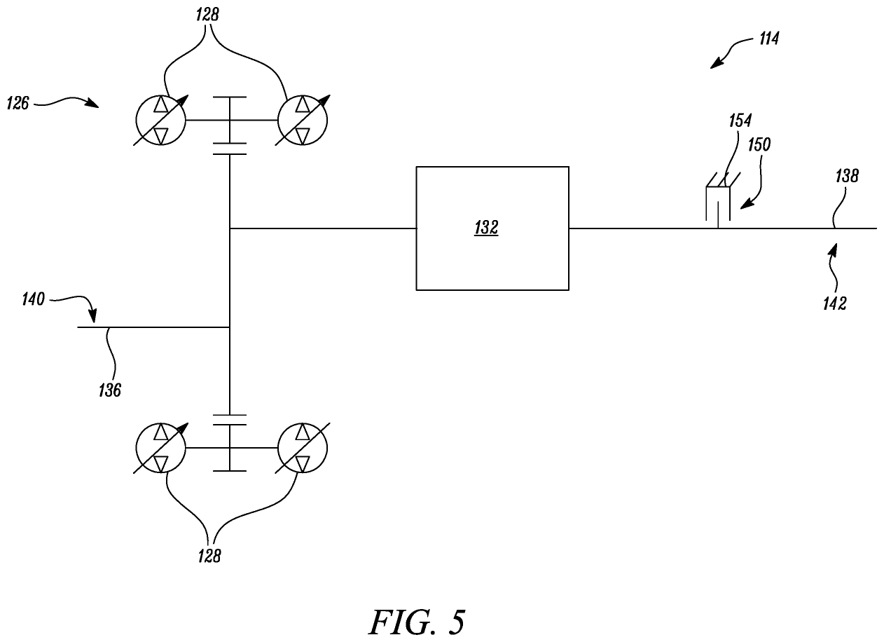

Further, as illustrated in FIG. 5, the power disengagement device 150 includes a brake assembly 154 disposed between the transmission system 132 and the power transmitting arrangement 134 (see FIG. 2). In such an example, the brake assembly 154 prevents rotation at the output end 142 of the transmission system 132. In an engaged position, the brake assembly 154 does not allow transmission of the output power from the transmission system 132 towards the power transmitting arrangement 134. In a disengaged position, the brake assembly 154 allows power flow from the transmission system 132 towards the power transmitting arrangement 134. In an example, the brake assembly 154 may be hydraulically operated. However, other techniques may be used for engaging/disengaging the brake assembly 154. The brake assembly 154 may include one or more of a disc brake, a drum brake, or any other type of brake assembly that disengages the transmission system 132 and the power transmitting arrangement 134.

Referring now to FIG. 2, the drivetrain 114 is controlled based on the desired output of the rotor 102. In some examples, the speed of the rotor 102 can be controlled based on the desired output of the rotor 102. The desired output of the rotor 102 may be based on the desired depth of cut, the travel speed of the machine 100, the hardness of material being cut, the desired material size, or the density of the material being cut. Accordingly, the speed of the rotor 102 may be controlled to achieve a desired outcome. For this purpose, the machine 100 includes the controller 130. In an example, the controller 130 may directly control one or more components of the drivetrain 114 based on the desired output of the rotor 102. For example, the controller 130 may change the drive ratios of the transmission system 132 or the gearbox 144, or control the power transmitting arrangement 134, based on the desired output of the rotor 102. Further, the controller 130 may also control the power disengagement device 150 (see FIGS. 3, 4, and 5) for transmitting or restricting power flow towards the rotor 102.

The controller 130 may embody a stand-alone device, or the controller 130 may embody an Electronic Control Unit (ECU) or an Engine Control Module (ECM) that may be present onboard the machine 100. The controller 130 may include a Central Processing Unit (CPU), a microprocessor, a microcontroller, a control unit, or another type of processing component capable of being programmed to perform certain functions/operations.

Moreover, the machine 100 includes a number of sensors 156, 158, 160 that assist in controlling the desired output of the rotor 102. In an example, the machine 100 may include the first sensor 156 to detect the travel speed of the machine 100. In another example, the machine 100 may include the second sensor 158 that detects the speed of the engine 108. In yet another example, the machine 100 may include the third sensor 160 that detects the speed of the rotor 102. The sensors 156, 158, 160 may include speed sensors that are generally known in the art that may allow speed detection, such as hall effect sensors, encoders, and the like. Additionally, the machine 100 may include other sensors for detecting other machine parameters that may assist in controlling the desired output of the rotor 102. Further, the controller 130 is communicably coupled to the sensors 156, 158, 160 and receives input signals from the sensors 156, 158, 160. Moreover, the controller 130 controls one or more components of the drivetrain 114 based on the input signals to achieve the desired output of the rotor 102.

### INDUSTRIAL APPLICABILITY

The present disclosure relates to the drivetrain 114 associated with the machine 100. The drivetrain 114 allows the operator to change the speed of the rotor 102 while the engine 108 is in the operating condition. Thus, a requirement of halting or reducing the speed of the machine 100 and/or the engine 108 is eliminated. The drivetrain 114 includes the transmission system 132 that is embodied as the powershift gearbox herein. An incorporation of such a powershift gearbox provides a variety of drive ratios and also allows shifting of the drive ratios without altering the load on the engine 108. Further, a combination of the transmission system 132 and the gearbox 144 further provides a wider range of rotor speeds without stopping machine operation.

The drivetrain 114 described herein includes a simple design. Further, the drivetrain 114 includes the power disengagement device 150 which may transmit or restrict power flow from the engine 108 to the rotor 102. Thus, the rotor 102 may be stopped as and when desired using the power disengagement device 150, even when the engine 108 is operating under load. Further, the drivetrain 114 along with the controller 130 and the sensors 156, 158, 160 allow optimization in rotor speeds based on the desired output of the rotor 102. Moreover, the present disclosure may allow dynamic and precise control of the rotor 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A milling machine comprising:
an engine that generates output power;
a rotor that receives the output power from the engine; and
a drivetrain coupled to the engine and the rotor for transmitting the output power to the rotor based on a desired output of the rotor, the drivetrain including:
a transmission system defining an input end operatively coupled to the engine for receiving the output power therefrom and an output end, wherein the transmission system allows variation in an output of the rotor without altering a load on the engine;
a power transmitting arrangement coupled to the output end of the transmission system; and
a gearbox coupled to the power transmitting arrangement and the rotor for transmitting the output power to the rotor, wherein the power transmitting arrangement is disposed between the transmission system and the gearbox.

2. The milling machine of claim 1, wherein the drivetrain further includes a power disengagement device for selectively disengaging the engine from the rotor in an operating condition of the engine.

3. The milling machine of claim 2, wherein the power disengagement device includes a clutch disposed on at least one of the input end and the output end of the transmission system.

4. The milling machine of claim 2, wherein the power disengagement device includes a brake assembly disposed between the transmission system and the power transmitting arrangement.

5. The milling machine of claim 1 further comprising a power take-off system disposed between the engine and the drivetrain, wherein the power take-off system receives the output power from the engine.

6. The milling machine of claim 5, wherein the power take-off system includes at least one hydraulic pump.

7. The milling machine of claim 1, wherein the power transmitting arrangement includes at least one of a pulley arrangement, a belt arrangement, a chain arrangement, and a gear drive.

8. The milling machine of claim 1, wherein the transmission system includes a powershift gearbox.

9. The milling machine of claim 1, wherein the drivetrain is controlled based on the desired output of the rotor.

10. The milling machine of claim 1, wherein the desired output of the rotor is based on at least one of a desired depth of cut, a travel speed of the milling machine, a hardness of material being cut, a desired material size, and a density of the material being cut.

11. A drivetrain for operating a rotor of a machine at a desired output, wherein the machine includes an engine that generates output power, the drivetrain comprising:
a transmission system defining an input end operatively coupled to the engine for receiving the output power therefrom and an output end, wherein the transmission system allows variation in an output of the rotor without altering a load on the engine;
a power transmitting arrangement coupled to the output end of the transmission system; and
a gearbox coupled to the power transmitting arrangement and the rotor for transmitting the output power to the rotor, wherein the power transmitting arrangement is disposed between the transmission system and the gearbox.

12. The drivetrain of claim 11 further comprising a power disengagement device for selectively disengaging the engine from the rotor in an operating condition of the engine.

13. The drivetrain of claim 12, wherein the power disengagement device includes a clutch disposed on at least one of the input end and the output end of the transmission system.

14. The drivetrain of claim 12, wherein the power disengagement device includes a brake assembly disposed between the transmission system and the power transmitting arrangement.

15. The drivetrain of claim 11 further comprising a power take-off system disposed between the engine and the drivetrain, wherein the power take-off system receives the output power from the engine.

16. The drivetrain of claim 15, wherein the power take-off system includes at least one hydraulic pump.

17. The drivetrain of claim 11, wherein the power transmitting arrangement includes at least one of a pulley arrangement, a belt arrangement, a chain arrangement, and a gear drive.

18. The drivetrain of claim 11, wherein the transmission system includes a powershift gearbox.

19. The milling machine of claim 1, wherein the drivetrain is controlled based on the desired output of the rotor.

20. The drivetrain of claim 11, wherein the desired output of the rotor is based on at least one of a desired depth of cut, a travel speed of the machine, a hardness of material being cut, a desired material size, and a density of the material being cut.
